(19) United States
(12) Patent Application Publication
(10) Pub. No.: US 2025/0077985 A1
(43) Pub. Date: Mar. 6, 2025

(54) UPDATING A GROUP MACHINE LEARNING MODEL BASED ON SHARED LOGIC FROM CUSTOMER MODEL INSTANCES

(71) Applicant: Nrby, Inc., Manchester, NH (US)

(72) Inventor: Niall MERRY, Miami, FL (US)

(21) Appl. No.: 18/822,175

(22) Filed: Aug. 31, 2024

Related U.S. Application Data
(60) Provisional application No. 63/580,313, filed on Sep. 1, 2023.

(51) Int. Cl. G06N 20/20; G06Q 30/0201; H04L 9/00

(52) U.S. Cl. CPC G06N 20/20; G06Q 30/0201; H04L 9/008

(57) ABSTRACT

Method and computer-readable media for updating a group ML model based on shared logic from customer data instances. The method includes receiving, at a communication interface of a central AI model, model logic from multiple remote customer instances of AI models, each customer instance of the AI models being based on the central AI model. The method includes updating the central AI model based on a combination of the model logic from the multiple remote customer instances. The method includes providing, via the communication interface, an AI model update to at least a subset of the multiple remote customer instances of the AI models.

### CROSS REFERENCE TO RELATED APPLICATION(S)

This application claims the benefit of and priority to U.S. Provisional Application Ser. No. 63/580,313, entitled “UPDATING A GROUP MACHINE LEARNING MODEL BASED ON SHARED LOGIC FROM CUSTOMER MODEL INSTANCES” and filed on Sep. 1, 2023, which is expressly incorporated by reference herein in its entirety.

### INTRODUCTION

The present disclosure relates generally to the field of machine learning and artificial intelligence.

Various industries, such as banking or cable/internet service providers, have a vast amount of customer data that may be collected due to customers interacting and/or utilizing the services provided to the customers. These industries must protect their customer data, and ensure that sensitive information within their customer data is not publicly released. These industries may be able to enhance or optimize the services provided to their customers based on the customer data collected due to customers interacting and/or utilizing the services provided.

### SUMMARY

The use of artificial intelligence and machine learning models can include centralized models that accumulate and process data from multiple sources. These centralized models can improve efficiency and accuracy. Aspects presented herein provide a system that balances efficient learning while upholding the highest standards of data privacy.

Aspects disclosed herein enable individual entities to use collected customer data with artificial intelligence (AI) or machine learning (ML) tools in way that enhances or optimizes the services provided to their customers. These AI tools may be configured to process the collected customer data and gather information in relation to the manner in which customers interact or utilize the services. These AI tools may identify or observe patterns or behavioral changes of how customers utilize or interact the services under different circumstances. These AI tools may utilize the customer data and optimize the manner in which services are provide in response to the observed patterns or behavioral changes of customers. However, the ability for AI tools to utilize customer data may be challenging due in part to requirements to safeguard sensitive customer information.

Aspects presented herein provide for processing customer data related to interactions with services provide to customers, such that sensitive customer information has been removed from the customer data. This processed customer data may then be provided to a central processing system that processes the customer data to update models or patterns based on customer interactions.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for sharing model logic from multiplex instances of a customer data model with a central model, in accordance with various aspects of the present disclosure.

FIG. 2 illustrates an example remote customer service system including a customer data model, in accordance with various aspects of the present disclosure.

FIG. 3 illustrates an example central processing system for a shared machine learning model that interacts with multiple instances of a customer data model, in accordance with various aspects of the present disclosure.

FIG. 4 is a flowchart illustrating a method for using an instance of a customer data model, in accordance with various aspects of the present disclosure.

FIG. 5 is a flowchart illustrating a method for updating a shared machine learning model using model logic received from multiple instances of a customer data model, in accordance with various aspects of the present disclosure.

FIG. 6 is a block diagram of a computer system on which the disclosed system and method can be implemented, in accordance with various aspects of the present disclosure.

### DETAILED DESCRIPTION

Various industries, including service providers such as financial services, medical services, education services, or cable/internet service providers, among other examples, have a vast amount of customer data that may be collected due to customers interacting and/or utilizing the services provided to the customers. These industries must protect their customer data, and ensure that sensitive information within their customer data and personal information is not publicly released. These industries may be able to enhance or optimize the services provided to their customers based on the customer data collected due to customers interacting and/or utilizing the services provided.

These industries may seek to use the collected customer data with artificial intelligence (AI) or machine learning (ML) tools in an effort to enhance or optimize the services provided to their customers. These AI tools may be configured to process the collected customer data and gather information in relation to the manner in which customers interact or utilize the services. These AI tools may identify or observe patterns or behavioral changes of how customers utilize or interact with the services under different circumstances. These AI tools may utilize the customer data and optimize the manner in which services are provided in response to the observed patterns or behavioral changes of customers. However, the ability for AI tools to utilize customer data may be challenging due in part to requirements to safeguard sensitive customer information.

Aspects presented herein provide for decentralized learning at individual customer instances associated with a centralized learning mechanism (e.g., a centralized processing system having a central AI/ML model), and the sharing of logic patterns from the decentralized customer instances with the central AI/ML model without the transfer of sensitive customer data. Instead, an individual customer instance abstracts and shares logic patterns with the centralized AI/ML model. The centralized AI/ML model may update the model based on shared logic patterns from multiple individual customer instances, and may provide model updates to the various customer instances, e.g., helping to provide rapid system-wide improvements while addressing individual localized needs.

For example, aspects disclosed herein include processing customer data related to interactions with services provided to customers using a decentralized or remote AI/ML model, such that sensitive customer information is removed from the customer data before sharing any identified logic patterns with a centralized AI/ML model. This abstracted logic pattern information may then be provided to a central processing system that processes the received information to update models or patterns based on customer interactions, business outcomes, etc.

In some instances, a service provider (e.g., 104a-c) may receive customer data based on customer interactions with the service provider. The customer data may be processed at the service provider such that sensitive customer information within the customer data is removed. The processed customer data includes, for example, information with regards to customer interactions is present while any such sensitive information is not present. The processed information, e.g., without any sensitive information, may be referred to as logic information. The logic information may be utilized, e.g., in connection with an AI/ML model, to identify optimized services to offer to customers. For example, a cable or internet service provider may utilize the logic information for a variety of different metrics in relation to servicing its customers, such as but not limited to, determining how customers are being managed, where capital is being deployed, or the like.

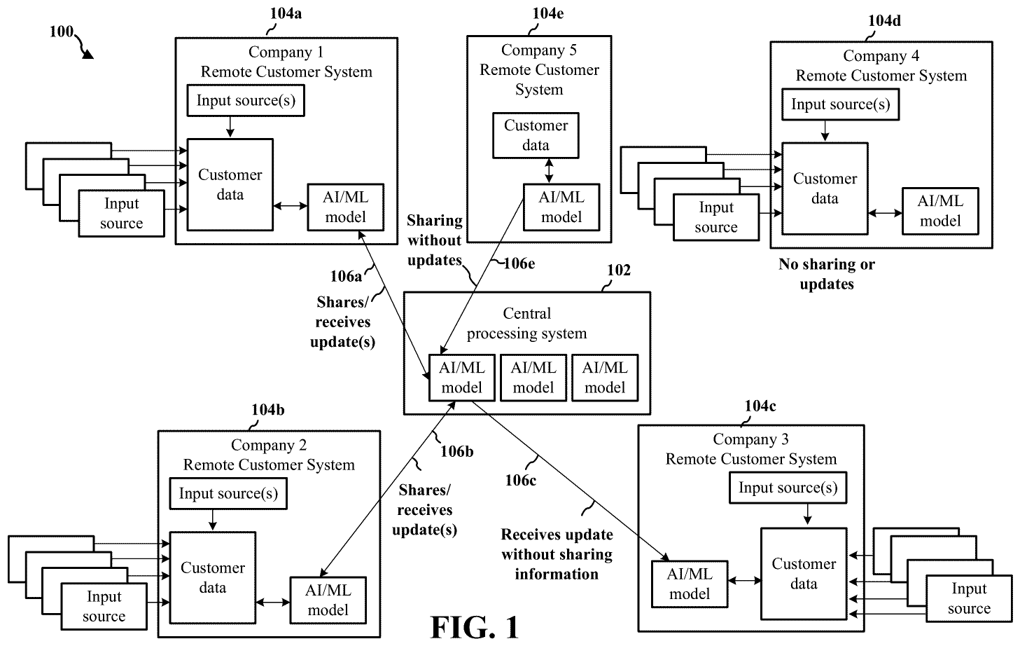

FIG. 1 illustrates a diagram showing a system 100 including various aspects of logic based learning for an AI/ML model. FIG. 1 shows a central processing system 102 that includes one or more AI/ML models. In some aspects, each model, of the one or more models at the central processing system 102, may correspond to a particular service type or entity type. In some aspects, each model, of the one or more models at the central processing system 102, may correspond to specific behavior patterns. As an example, an AI/ML model at the central processing system 102 may be a model for cable service providers. As another example, an AI/ML model at the central processing system 102 may be for financial institutions. As another example, one AI/ML model at the central processing system 102 may be for a first type of bank (with the type based on size, region, type of services provided, among other examples) and a second AI/ML model at the central processing system 102 may be for a second type of bank. Although specific examples of AI/ML models are given to illustrate the concept, the aspects presented herein may be applied for AI/ML models for various business types, entities, organizations, or service providers.

Individual customer instances, e.g., remote customer systems (e.g., 104a, 104b, 104c, 104d, and 104c), may each have a corresponding AI/ML model, e.g., associated with one of the models at the central processing system 102. In some aspects, the central processing system 102 may provide a copy or version of the AI/ML model from the central processing system 102 to the individual customer instances (e.g., 104a-104e). In other aspects, the customers instances (e.g., 104a-104c) may otherwise obtain a local AI/ML model and establish a connection (e.g., 106a, 106b, 106c, 106e) to the corresponding AI/ML model at the central processing system 102. The connection may be provided as a communication interface between the decentralized (e.g., remote) AI/ML model (e.g. at the customers instances (e.g., 104a-104e)) and the corresponding, centralized AI/ML model at the central processing system 102. The communication interface may include a model, a network interface, a communications portal, and/or other components to enable the exchange of communication via a communication path (e.g., whether a wired path, a cable path, a fiber optic path, a wireless link, and/or other communication channel between computer systems).

Each customer instance (e.g., 104a, 104b, 104c, 104d, and 104c) of the AI/ML model operates independently of the other customer instances. Each customer instance allows for user control of the connection to the central AI/ML model and control of the amount of information, e.g., including logic sharing and/or receiving of model updates, that is shared between an individual, decentralized AI/ML model at the customer instance (e.g., 104a-104c) and the central AI/ML model at the central processing system 102.

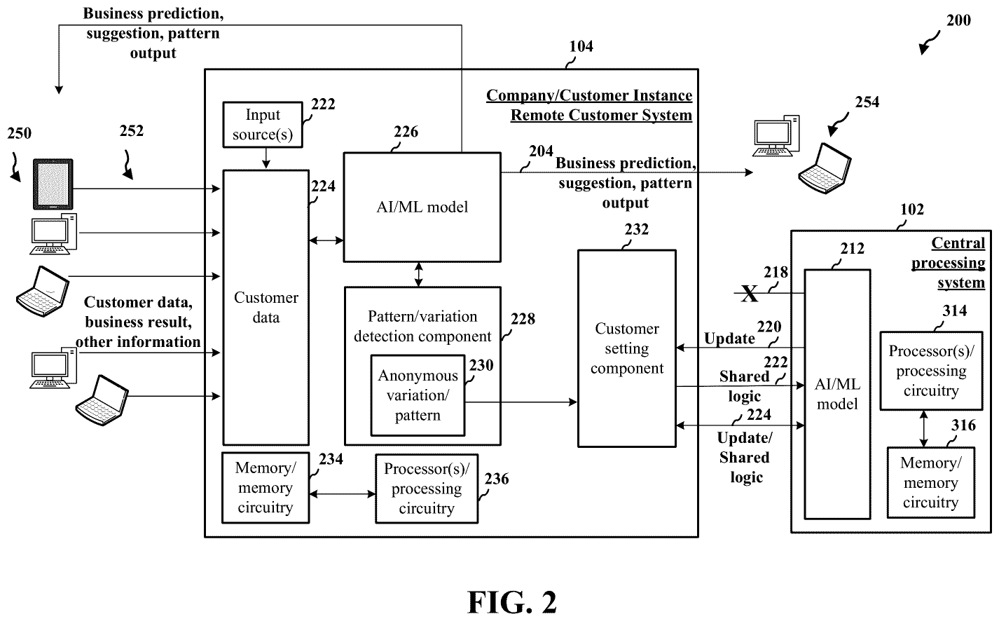

FIG. 2 illustrates a more detailed diagram 200 of an example customer instance (e.g., such as one of 104a, 104b, 104c, 104d, or 104c). As illustrated, the example customer system (e.g., 104) may include memory 234 (or memory circuitry) and one or more processors 236 (or processor circuitry) configured to cause the computer system to perform the aspects described in connection with the use of the AI/ML model, as described herein. The infrastructure for the customer instance 104 may be deployed on premises at a customer location or may be provided in dedicated cloud containers. The customer instance may be configured to process, understand, and interact in real-time with customer specific data. The customer instance 104 (e.g., used to represent potential aspects any of any individual customer instance of 104a-14c) may obtain data 252 from one or more input sources 250 or 222. For example, the input sources may be remote devices having a communication interface to the customer processing system or may be a component, or source, that is comprised within the customer system. The data may be based on customer interactions with one or more customers of the company or service provider, e.g., interactions of the company/service provider with the customer(s). The input data may include customer information, business results, and other information. As an example, the input information for a service provider may include sales information, profit information, cost information, maintenance information, customer cancelation information, customer retention information, customer billing information, etc. As one example to illustrate the concept of such customer data, a cable company may input information for which sales representatives attempted to sell cable services to a street of residences. The data may identify the results of the offers, e.g., a percentage of new customers that accepted the offer. The information may include other information surrounding the sales, such as addresses to which the offer was made, a region to which the offer was made, a type of residence to which the offer was made, a type of service being offered, a manner in which the offer was made, and/or other information. For a customer instance in a financial field, the information that is input may relate to fraud monitoring tools and specific instances of fraud that were identified and resolved. The data 224 may be provided to a AI/ML model 226 at the customer instance to generate an output based on the customer data 224 and a trained AI/ML model. In some aspects, the output 204 may include a business prediction, a business suggestion, or an identification of a pattern (e.g., to one or more user terminals 254). In some aspects, the data 224 may be used as feedback data to refine a previously trained AI/ML model 226. For example, if the model output a business suggestion or prediction. Customer data may be collected about the business result after implementing the business suggestion, and the customer data may be used to adjust or refine the AI/ML model.

The AI/ML model may identify one or more patterns or variations that could improve the accuracy of the output from the AI/ML model. For example, the AI/ML model 226 may use reinforcement learning with reward mechanisms tailored to specific business performance indicators (e.g., key performance indicators (KPIs)) of the customer. The use of the AI/ML model 226 to analyze the customer data 224 and the identification of patterns or variations is performed in a decentralized manner, e.g., separate from and independent of the central processing system. The customer system may adjust the logic patterns of the AI/ML model 226 based on the feedback and/or analysis of customer data 224.

In connection with the AI/ML model 226, a pattern or variation detection component 228 may identify such logic or patterns from the AI/ML model analysis of the customer data 224. The logic/pattern information includes an abstraction without any sensitive customer data. In some aspects, the component 228 may include a component 230 that verifies that the information (logic/pattern information based on analysis of customer data) is anonymous and does not include any sensitive customer information. The logic pattern may then be provided to the central processing system 102, e.g., via a customer setting component 232 that controls an interface between the customer instance 104 and the central processing system 102.

As an example, instead of raw data (e.g., the obtained customer data), abstracted logic patterns (e.g., mathematical representations or coded summaries) may be generated, which may be represented as an abstract logic pattern based on an analysis of the customer data. For example, the customer data may be processed by the AI/ML model 226 to obtain a logic pattern that is a function of the customer data yet does not include or share any of the actual customer data. The centralized processing system 102 does not access customer data or store customer data from individual customer instances 104. The interface between the central processing system 102 and the customer instance 104 does not allow the central processing system to access customer data or to pull information from the customer instance 104. Instead, the central processing system is configured to receive information according to the individual customer settings at the customer setting component 232. The customer instance 104 controls the flow of information to and from the central processing system 102.

The customer setting component 232 may be configured to: (1) receive model updates from the central AI/ML model 212, as shown at 220 (and 106c in FIG. 1), (2) share logic information with the central processing system, as shown at 222 (106e in FIG. 1), or (3) share logic information and receive model updates with the central processing system, as shown at 224 (and at 106a, 106b in FIG. 1). In some aspects, the customer setting component 232 may be configured to neither share logic patterns or receive model updates from the central AI/ML model 212, as shown at 218, which may be referred to as blocking a communication interface between the customer AI/ML model 226 and the central AI/ML model 212.

The user setting may provide a user interface that enables a user to select and change a setting at different times. For example, at a first time, the user interface may be set to receive a selection to receive model updates without sharing identified logic patterns. At a second time, the user interface may be set to receive a change of the setting to allow for sharing of logic patterns at the receipt of model updates. At a third time, the user interface may be set to receive a change of the setting to neither share logic patterns nor receive model updates, so that the AI/ML model 226 operates in an independent and disconnected manner from the AI/ML model 212. The user may change the settings according to user preferences at any particular time. As well, the user interface may allow for a more granular user setting, e.g., enabling the customer instance to share some types of logic patterns and not to share other types of logic patterns that are identified in the use of the AI/ML model 226. This allows individual customer instances (e.g., 104a-104c) to opt in or opt out of sharing certain types of logic patterns identified with the instance of the AI/ML model processing the customer data 224 of the particular customer instance. For example, logic patterns relating to some business outcomes or some business information may be identified using the AI/ML model yet may be maintained as private for an individual company, while other logic patterns for more general business information may be shared with the central AI/ML model. In some aspects, logic patterns may have different layers or levels. For example, there may be individual patterns that are identified using the AI/ML model analysis of the customer data. There may be one or more aggregates of patterns based on various individual patterns that are identified using the AI/ML model analysis of the customer data. There may be certain types of patterns, such as cause and effect type patterns that are identified. The user setting may enable a user to select between types of logic patterns to be shared and/or layers or levels of logic patterns to be shared with the central AI/ML model 212.

The central processing system 102 may process the logic information from the one or more service providers (e.g., 104) using an AI/ML model 212 to detect new patterns or models based on a combination of logic patterns from various customers instances, e.g., using one or more processors 314 and memory 316. For example, the received logic information may be used to update or refine the central AI/ML model 212.

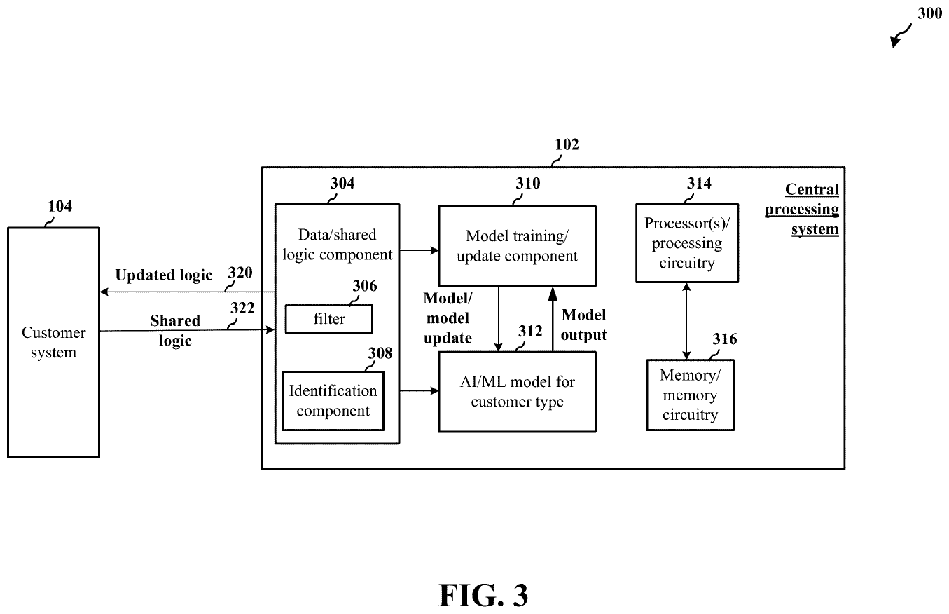

FIG. 3 illustrates a more detailed diagram 300 of the central processing system 102 (e.g., as discussed in connection with FIG. 1 and FIG. 2), including the reception of logic information and the provision of model updates. The infrastructure for the central processing system 102 may be provided in one or more secure, cloud based servers with redundant checks and failover mechanisms, for example. The central processing system 102 may serve as a hub for the aggregation of logic learning from multiple customer instance AI/ML nodes. As an example, the central processing system may employ a combination of transfer learning and meta learning to integrate diverse logic from varying customer instances. The central processing system 102 may receive shared logic information 322 as input at a data/shared logic component 304. The central processing system 102 collects abstracted logic patterns from each customer instance that shares logic pattern information for a particular AI/ML model. The central processing system 102 amalgamates these patterns, refines the core logic of the AI/ML model 312, and generates an enhanced logic model, which may also be referred to as a model update. For example, the central processing system processes and combines multiple abstracted patterns to obtain refined logic as a function of the abstracted patterns. The data/shared logic component 304 may filter 306 the shared logic to obtain relevant logic information. The data/shared logic component 304 may identify new or changed patterns from the shared logic at identification component 308. The data/shared logic component 304 may output data to a model training/update component 310 and/or an AI/ML model 312 for a corresponding customer type. The model training/update component 310 may assist in further training or updating a model based on the shared logic, and may provide information to the AI/ML model 312 for the corresponding customer type. The AI/ML model 312 for the customer type may provide a model output for training by the AI/ML model 312 for the customer type. The central processing system 102 refines the logic patterns of the central AI/ML model to update the AI/ML model, e.g., without accessing or storing specific customer data that was obtained at the individual customer instances. The use of abstracted logic patterns received from the individual customer instances is devoid of sensitive information, which helps to meet data privacy mandates, such as the general data protection regulation (GDPR) or the California Consumer Privacy Act (CCPA), among other examples. The two-tiered learning approach intertwines operation on a centralized (that incorporates a more encompassing training based on more customer data) and decentralized basis (that analyzes customer data within a customer instance before providing abstracted logic to a central AI/ML model) to improve the use of an AI/ML model refinement while maintaining customer data privacy through the process of abstracting, transmitting, refining, and re-distributing logic patterns without compromising data privacy.

Thus, as shown in FIG. 1, the central processing system 102 may be configured to receive the logic pattern information from one or more of the customer instances (e.g., 104a, 104b, or 104c), and a combination of the logic pattern information is processed by the central processing system 102 to identify changes or updates to a corresponding central AI/ML model. The central processing system 102 may then provide the updated AI/ML information, e.g., one or more logic updates after AI/ML refinement of the central AI/ML model, to the various customer instances (e.g., 104a-140c), such that the customer instances may use the updated logic (e.g., received at 320) with their remote, local version of the AI/ML model to enhance and/or optimize the services they provide to their customers. The abstraction at an AI/ML logic level enables different companies or providers to share AI/ML information in a way that benefits each other while maintaining the privacy of their individual customer information.

In some aspects, for example, a service provider may comprise a first cable service provider (e.g., at customer instance 104a) that may provide logic information to the central processing system 102. The central processing system 102 may process the logic information for new or updated patterns, which are used to refine or update a central AI/ML mode for cable service providers. The central processing system 102 may then provide the new or updated patterns, e.g., model updates, back to the first cable service provider (e.g., at customer instance 104a), to allow the first cable service provider to optimize the services provided to their customers. For example, the cable service provider (e.g., at customer instance 104a) may use output from their individual instance of the AI/ML model to identify, determine, predict, or suggest potential business decisions relating to maintenance, sales, billing, infrastructure, etc. that will provide an optimal business outcome.

In some instances, the central processing system 102 may also provide the updated patterns, e.g., AI/ML model updates, to one or more other cable service providers (e.g., 104b or 104c) that may utilize the updated pattern based on the logic information derived from customers of the first cable service provider (e.g., 104a) to update their local AI/ML model. The updated patterns do not include sensitive customer information for customers of the first cable service provider (e.g., 104a), but rather include an updated pattern based on customer usage of the first cable service provider. The updated pattern that is being provided to the first cable service provider (e.g., 104a) and/or the one or more other cable service providers (e.g., 104b or 104c) is information that has been learned from the interactions between the first cable service provider (e.g., 104a) and its customers. The learned interactions may be useful in helping the first cable service provider (e.g., 104a) and/or the one or more other cable service providers (e.g., 104b or 104c) to enhance or optimize the customer experience. By sharing the updated patterns, the central processing system 102 may allow service providers to learn from customer interactions with a different service provider.

The logic information (e.g., that a customer instance such as 104a shares with the central processing system 102) may comprise a string of activity of customers (or contacts or potential customers) without any identifying information of the actual customers that were involved in such activity. The logic information is in the abstract and only includes information related to customer interactions, which may be utilized to determine patterns for different environments or instances of customers interacting with service providers. For example, the logic information that the customer instance 104a shares with the central processing system 102 may include customer interactions under different weather instances (e.g., snow, rain, sunny, etc.). Customer interactions may differ under different weather conditions, and the weather information may be shared with other service providers. As an example for a restaurant service provider, customer interactions may have a direct connection with particular weather conditions, and such pattern information may be shared by an individual restaurant (or restaurant company) with a central processing system 102 that collects logic information from various restaurants.

In some instances, the one or more service providers (e.g., 104) that provide logic information to the central processing system 102 and/or receive the updated pattern or model from the central processing system 102 may provide the same service(s). In some aspects, the one or more service providers (e.g., 104) that provide logic information to the central processing system 102 and/or receive the updated pattern or model from the central processing system 102 may provide different services. The central processing system 102 may update the patterns that it provides to the service providers (e.g., 104a-104c) on a continual or predetermined basis. For example, when the central processing system 102 detects a new pattern based on logic information, the central processing system may provide the updated pattern to services providers automatically or at a predetermined (or previously scheduled/coordinated) time. The data stored at the central processing system 102 comprises the logic information and does not include sensitive customer information, such that customer data of individual customer instances (e.g., 104a-104c) is protected.

The central processing system 102 may provide service providers with an initial pattern or model that the service providers may utilize in providing their services to customers. The service providers may provide logic information related to customer interactions to the central processing system, such that the central processing system may process the logic information and update the initial pattern or model provided to the service providers. The service providers (e.g., 104a-104c) may repeatedly provide the central processing system 102 with logic information related to the updated pattern or AI/ML model such that the central processing system 102 is continually updating or improving the pattern or model provided to the service providers. The updated patterns or models may be based on logic information from one or more of the service providers.

For example, a restaurant may provide logic information to the central processing system 102 related to user interaction. The central processing system 102 may utilize such logic information from the restaurant and update patterns or models which may then be provided to the restaurant and/or a different company that provides a service to customers (e.g., utility company, gas company, etc.). The updated patterns or models may assist the restaurant in operation of the restaurant, such as but not limited to, optimizing staffing of wait staff or other employees based on customer interactions indicated in the logic information, forecasting supply orders, etc. The different company may also utilize the updated pattern(s) or model(s) to assist the different company in operation of the different company based on the logic information provided by the restaurant. The different company (e.g., utility company, gas company, wireless communication provider, etc.) may have some overlap in customers with the restaurant, such that customer interactions with the restaurant may be useful or beneficial for the operation of the different company and/or services provided by the different company. In some instances, the different company may not have any overlap of customers with the restaurant, but the manner in which the customers interact with the restaurant may be useful or beneficial for the different company.

In some aspects, the multiple service providers that provide logic information and/or receive updated models or patterns may be located in the same geographic region, or completely different geographic region (e.g., city, state, country). The updated models or patterns for service providers may be provided to different service providers to enhance or optimize the operations of the service providers without including sensitive customer information within the logic information used to generate the updated models or patterns. At least one advantage of the disclosure is that information may be shared with other service providers, and the shared information may assist or optimize the operations of the service provided to customers. For example, the shared logic information may identify business decisions to reduce unnecessary costs and expenditures, drive new revenue streams based in part on new or learned patterns of opportunity, assist in making decisions in relation to capital and resource investments, or allow new ventures to utilize knowledge learned by the logic information to derive or update the models or patterns.

In some examples, NLP Models, such as BERT and its variants, may be employed for understanding textual customer feedback. For structured reasoning, Neural Logic models may merge traditional logic with neural networks, allowing for rigorous yet adaptive reasoning.

In a non-limiting example in which cable companies may correspond to the customer instances (e.g., 104a-e), this may translate to accurate predictions of network downtimes, optimized maintenance schedules, and proactive customer communication, among other examples.

Aspects presented herein provide for differential privacy. For example, the logic that is shared from a customer AI/ML model to the central AI/ML model may be structures to ensure that the shared logic patterns cannot be reverse engineered to reveal specifics about any customer's data.

In some aspects, Zero-Knowledge Proofs may be used to validate shared logic from customer AI/ML models. For example, the central AI/ML model may validate the integrity of received logic without ever understanding its specific content.

As the number of customer instances 104 grows, the load on the central processing system 102 may grow. In some aspects, a central processing system or AI/ML model may be distributed into regional clusters. In some aspects, customer instances may evolve, leading to divergent logic paths. Regular calibration cycles and drift detection can be employed to address the potential for divergent logic paths. As well, latency may be reduced to ensure a swift feedback loop as many computations may be performed close to the data source, e.g., based on edge computing principles. For example, the identification of patterns and variations is performed at customer instances, and the identified logic/pattern is shared with the central AI/ML model.

The intricate interplay of edge and central learning, combined with state-of-the-art encryption and data privacy measures, helps the logic-based learning AI/ML to adapt and serve various businesses in ever-more tailored ways.

As an example of an AI learning flow, the AI/ML models 226 at the customer instances 104 may start with a pre-trained knowledge base from the central AI/ML model 212. In some aspects, the AI/ML model may employ techniques such as Bayesian Optimization to provide efficient exploration of a solution space.

Then, incremental learning may be applied at the edge, e.g., at each decentralized customer instance. For example, each instance may employ deep learning models to find patterns in structured (e.g., database records) and unstructured (e.g., customer interactions) data. As patterns are recognized, the AI/ML model 226 refines its internal logic using mechanisms like neural program synthesis, which enables it to generate new logic rules programmatically.

In some aspects, homomorphic encryption and secure data transfer may be employed at the customer instance 104. For example, the pattern variation/detection component 228 may abstract logic rules from data 224, which can be encrypted using Fully Homomorphic Encryption (FHE), to ensure that the AI/ML model 212 at the central processing system can process the logic without ever decrypting it. For the communication interface between the AI/ML model of the customer instance 104 and the central AI/ML model 212, secure channels using TLS/SSL protocols with Perfect Forward Secrecy can be used to provide safe transmission of logic rules.

After the abstract logic is shared by one or more customer instances 104, a central aggregation and synthesis may be performed at the central processing system 102. For example, the central processing system 102 may use ensemble learning techniques to merge logic from different customer instances 104. The central processing system 102 may further use advanced neural architectures, such as transformer models, to help in assimilating diverse logic fragments, ensuring comprehensive learning.

Once the central processing system 102 determines an update to the AI/ML model 212 based on the abstract logic received from one or more customer instances, the central processing system may perform logic diffusion by dispatching version controlled logic updates to individual customer instances 104. In some aspects, the central processing system may provide delta updates so that changes in logic (not the entire logic set) are transmitted, optimizing bandwidth usage for the communication interface between the customer instance 104 and the central processing system 102.

In some aspects, the AI/ML model at the central processing system 102 and/or the AI/ML model at each of the remote customer systems (e.g., 226) may use machine-learning algorithms, deep-learning algorithms, neural networks, reinforcement learning, regression, boosting, or advanced signal processing methods for receiving content and identifying content of interest for particular users.

Reinforcement learning is a type of machine learning that involves the concept of taking actions in an environment in order to maximize a reward. Reinforcement learning is a machine learning paradigm. Other paradigms include supervised learning and unsupervised learning. Basic reinforcement may be modeled as a Markov decision process (MDP) with a set of environment states and agent states, as well as a set of actions of the agent. A determination may be made about a likelihood of a state transition based on an action and a reward after the transition. The action selection by an agent may be modeled as a policy. The reinforcement learning may enable the agent to learn an optimal, or nearly-optimal, policy that maximizes a reward. Supervised learning may include learning a function that maps an input to an output based on example input-output pairs, which may be inferred from a set of training data, which may be referred to as training examples. The supervised learning algorithm analyzes the training data and provides an algorithm to map to new examples.

Regression analysis may include statistical analysis to estimate the relationships between a dependent variable (e.g., an outcome variable) and one or more independent variables. Linear regression is an example of a regression analysis. Non-linear regression models may also be used. Regression analysis may include estimating, or determining, relationships of cause between variables in a dataset.

Boosting includes one or more algorithms for reducing variance or bias in supervised learning. Boosting may include iterative learning based on weak classifiers (e.g., that are somewhat correlated with a true classification) with respect to a distribution that is added to a strong classifier (e.g., that is more closely correlated with the true classification) in order to convert weak classifiers to stronger classifiers. The data weights may be readjusted through the process, e.g., related to accuracy.

Among others, examples of machine learning models or neural networks that may be included in the AI/ML model at the central processing system 102 and/or the AI/ML model at each of the remote customer systems (e.g., 226) include, for example, artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; deep convolutional networks (DCNs) configured with additional pooling and normalization layers; and deep belief networks (DBNs).

In some aspects, an example machine learning model, such as an artificial neural network (ANN), that includes an interconnected group of artificial neurons (e.g., neuron models) as nodes. Neuron model connections may be modeled as weights, in some aspects. Machine learning models, such as the AI/ML model at the central processing system 102 and/or the AI/ML model at each of the remote customer systems (e.g., 226), may provide predictive modeling, adaptive control, and other applications through training via a dataset relating to interactions with various customers and other business information. A machine learning model may be adapted, e.g., based on external or internal information processed by the machine learning model. In some aspects, a machine learning model may include a non-linear statistical data model and/or a decision making model. Machine learning may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. The term layer may indicate an operation on input data. Weights, biases, coefficients, and operations may be adjusted in order to achieve an output closer to the target output. Weights and biases are examples of parameters of a trained machine learning model. Different layers of a machine learning model may be trained separately.

A variety of connectivity patterns, e.g., including any of feed-forward networks, hierarchical layers, recurrent architectures, feedback connections, etc., may be included in a machine learning model. Layer connections may be fully connected or locally connected. For a fully connected network, a first layer neuron may communicate an output to each neuron in a second layer. Each neuron in the second layer may receive input from each neuron in the first layer. For a locally connected network, a first layer neuron may be connected to a subset of neurons in the second layer, rather than to each neuron of the second layer. A convolutional network may be locally connected and may be configured with shared connection strengths associated with the inputs for each neuron in the second layer. In a locally connected layer of a network, each neuron in a layer may have the same, or a similar, connectivity pattern, yet having different connection strengths.

A machine learning model, artificial intelligence component, or neural network may be trained, such as training based on supervised learning. During training, the machine learning model may be presented with an input that the model uses to compute to produce an output. The actual output may be compared to a target output, and the difference may be used to adjust parameters (e.g., weights, biases, coefficients, etc.) of the machine learning model in order to provide an output closer to the target output. Before training, the output may not be correct or may be less accurate. A difference between the output and the target output, may be used to adjust weights of a machine learning model to align the output is more closely with the target.

A learning algorithm may calculate a gradient vector for adjustment of the weights. The gradient may indicate an amount by which the difference between the output and the target output would increase or decrease if the weight were adjusted. The weights, biases, or coefficients of the model may be adjusted until an achievable error rate stops decreasing or until the error rate has reached a target level.

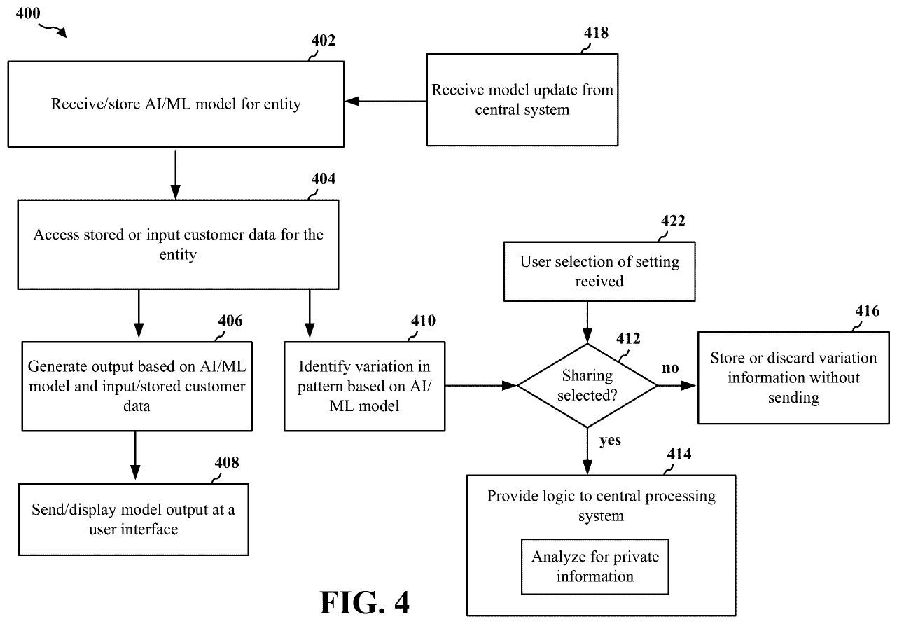

FIG. 4 is a flowchart 400 of a method of generating or updating a model based on customer interactions for a service provider. The method may be performed at a decentralized customer instance. In some aspects, the method may be performed by an AI/ML model component 675 of a processing system that may be part of a customer instance 104. FIG. 1 and FIG. 2 illustrate examples aspects of a customer instance 104, 104a, 104b, 104c, 104d, and 104c. FIG. 3 illustrates an example of interaction between a customer instance 104 and a central processing system 102.

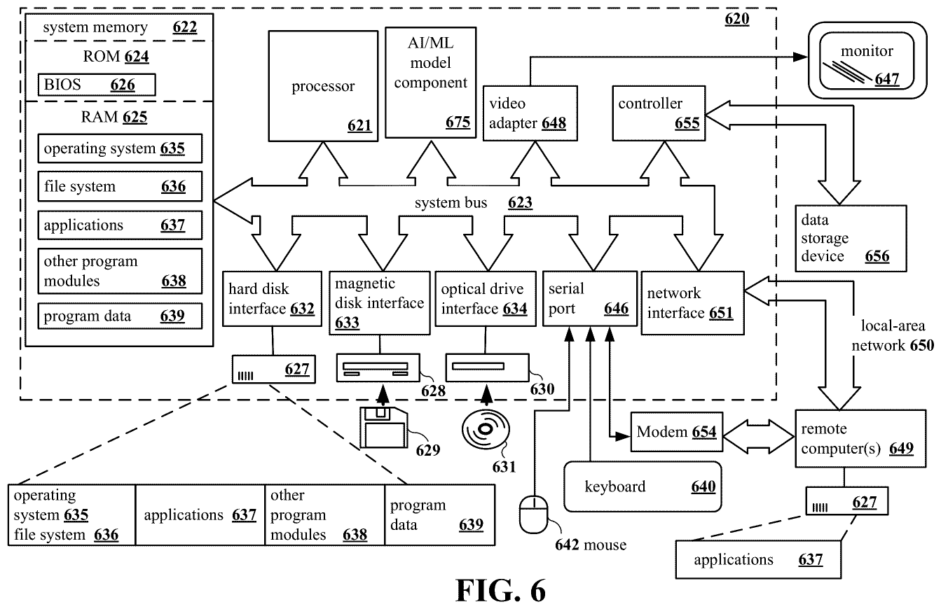

At 402, a service provider may receive or store an AI/ML model. An example of an AI/ML model is described in connection with FIGS. 1-3. The receipt or storage of the AI/ML model may be performed, e.g., in some aspects by the AI/ML model component 675 in FIG. 6.

At 404, the service provider may access stored or input customer data. In some aspects, at 406, the service provider may generate an output based on the AI/ML model and input/stored customer data. Various aspects of processing customer data and providing an output from an AI/ML model at a customer instance are described in connection with FIG. 2. The access and generation of output may be performed, e.g., by the AI/ML model component 675 in FIG. 6.

At 408, the service provider may send/display a model output at a user interface. For example, the AI/ML model component 675 may provide the output to the monitor 647 in FIG. 6.

In some aspects, at 410, a variation in a pattern may be identified based on the AI/ML model. The variation may be identified, e.g., by the AI/ML model component 675 in FIG. 6, for example. At 412, a determination as to whether to share the logic related to the variation in the identified pattern is determined. If the logic is not to be shared, the service provider at 416, may store or discard the variation information. For example, the AI/ML model may update its own logic without sharing the logic with the central processing system. If the logic is determined to be shared, the service provider at 414, may provide anonymous pattern variation information to a central model or processing system. Examples of sharing and not sharing such logic patterns are described in connection with FIGS. 1-3. The determination and sharing or discarding of the information may be performed, e.g., in some aspects, by the AI/ML model component 675 in FIG. 6. As illustrated at 422, a user selection of a setting for sharing logic and/or receiving model update information may be received. The determination, at 412, may be based on the selection received at 422, e.g., as described in connection with the example in FIG. 2.

In some aspects, at 418, the service provider may receive a model update from the central processing system. If the selected update is received within the model update, the service provider may incorporate the update into the stored AI/ML model. The receipt and incorporation of the update may be performed, e.g., in some aspects, by the AI/ML model component 675 in FIG. 6.

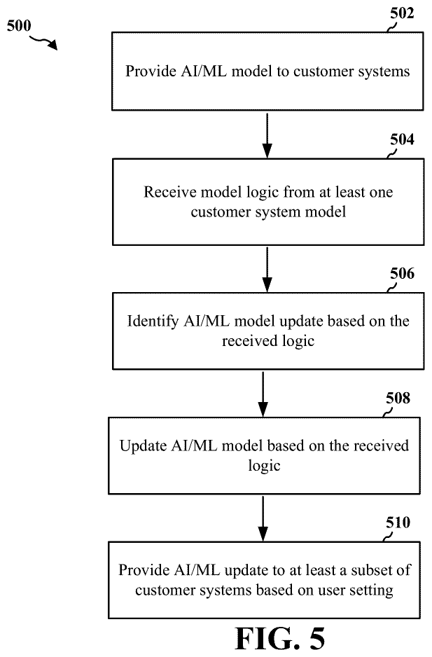

FIG. 5 is a flowchart 500 of a method of generating or updating a model based on customer interactions for a service provider. The method may be performed at a central processing system, e.g., 102. In some aspects, the method may be performed by an AI/ML model component 675 of a processing system that may be part of the central processing system 102.

At 502, a central processing system may provide an AI/ML model to one or more customer systems. FIGS. 1-3 illustrate various example aspects of a central processing system 102. In some aspects, the AI/ML model may be provided via a communication interface between a central processing system and a customer system.

At 504, the central processing system may receive model logic based on customer data analysis from at least one customer system model. FIGS. 1-3 illustrate example aspect of receiving logic pattern information from various remote customer instance of an AI/ML model.

At 506, the central processing system may identify one or more AI/ML model updates based on received logic. At 508, the central processing system may update the AI/ML model based on the received logic. At 510, the central processing system may provide the AI/ML model update to at least a subset of customer systems based on user settings. For example, as described in connection with FIGS. 1-3, at any given time, one or more customer instances may have a setting to not receive AI/ML updates. The interaction between the customer instance and the central AI/ML model may be controlled by the customer instance, and the central AI/ML model may not access logic or update a remote AI/ML model without access being granted by the customer instance.

FIG. 6 is a block diagram illustrating a general-purpose computer system 620 on which aspects of systems and methods for logic based learning between an AI/ML at a customer instance and a central AI/ML model, e.g., as described in connection with any of FIGS. 1-5 may be implemented in accordance with an example aspect. The computer system 620 can correspond to the physical server(s) on which the application 617 and/or the recommendation service 620 is executing, for example, described earlier.

As shown, the computer system 620 (which may be a personal computer or a server) includes a central processing unit 621, a system memory 622, and a system bus 623 connecting the various system components, including the memory associated with the central processing unit 621. As will be appreciated by those of ordinary skill in the art, the system bus 623 may comprise a bus memory or bus memory controller, a peripheral bus, and a local bus that is able to interact with any other bus architecture. The system memory may include permanent memory (ROM) 624 and random-access memory (RAM) 625. The basic input/output system (BIOS) 626 may store the basic procedures for transfer of information between elements of the computer system 620, such as those at the time of loading the operating system with the use of the ROM 624.

The computer system 620 may also comprise a hard disk 627 for reading and writing data, a magnetic disk drive 628 for reading and writing on removable magnetic disks 629, and an optical drive 630 for reading and writing removable optical disks 631, such as CD-ROM, DVD-ROM and other optical media. The hard disk 627, the magnetic disk drive 628, and the optical drive 630 are connected to the system bus 623 across the hard disk interface 632, the magnetic disk interface 633, and the optical drive interface 634, respectively. The drives and the corresponding computer information media are power-independent modules for storage of computer instructions, data structures, program modules, and other data of the computer system 620.

An example aspect comprises a system that uses a hard disk 627, a removable magnetic disk 629 and a removable optical disk 631 connected to the system bus 623 via the controller 655. It will be understood by those of ordinary skill in the art that any type of media 656 that is able to store data in a form readable by a computer (solid state drives, flash memory cards, digital disks, random-access memory (RAM) and so on) may also be utilized.

The computer system 620 has a file system 636, in which the operating system 635 may be stored, as well as additional program applications 637, other program modules 638, and program data 639. A user of the computer system 620 may enter commands and information using keyboard 640, mouse 642, or any other input device known to those of ordinary skill in the art, such as, but not limited to, a microphone, joystick, game controller, scanner, etc. Such input devices typically plug into the computer system 620 through a serial port 646, which in turn is connected to the system bus, but those of ordinary skill in the art will appreciate that input devices may be also be connected in other ways, such as, without limitation, via a parallel port, a game port, or a universal serial bus (USB). A monitor 647 or other type of display device may also be connected to the system bus 623 across an interface, such as a video adapter 648. In addition to the monitor 647, the personal computer may be equipped with other peripheral output devices (not shown), such as loudspeakers, a printer, etc.

Computer system 620 may operate in a network environment, using a network connection to one or more remote computers 649. The remote computer (or computers) 649 may be local computer workstations or servers comprising most or all of the aforementioned elements in describing the nature of a computer system 620. Other devices may also be present in the computer network, such as, but not limited to, routers, network stations, peer devices or other network nodes.

Network connections can form a local-area computer network (LAN) 650 and a wide-area computer network (WAN). Such networks are used in corporate computer networks and internal company networks, and they generally have access to the Internet. In LAN or WAN networks, the computer system 620 is connected to the local-area network 650 across a network adapter or network interface 651. When networks are used, the computer system 620 may employ a modem 654 or other modules well known to those of ordinary skill in the art that enable communications with a wide-area computer network such as the Internet. The modem 654, which may be an internal or external device, may be connected to the system bus 623 by a serial port 646. It will be appreciated by those of ordinary skill in the art that said network connections are non-limiting examples of numerous well-understood ways of establishing a connection by one computer to another using communication modules.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module, element, or component may also be implemented as a combination of the two, with particular functions facilitated by hardware alone, and other functions facilitated by a combination of hardware and software. In particular implementations, at least a portion, and in some cases, all, of a module, element, or component may be executed on one or more processors of a general purpose computer. Accordingly, each module may be realized in a variety of suitable configurations, and should not be limited to any particular implementation or example herein. An element, or any portion of an element, or any combination of elements may be implemented as a “processing system” that includes one or more processors. When multiple processors are implemented, the multiple processors may perform the functions individually or in combination. One or more processors in a processing system may execute stored instructions, which may be referred to as software, firmware, middleware, microcode, hardware description language, or otherwise, e.g., instructions, instruction sets, code, code segments, program code, programs, subprograms, software components, applications, software applications, software packages, routines, subroutines, objects, executables, threads of execution, procedures, functions, or any combination thereof.

In one configuration, the AI/ML model component 675 and/or the computer system 620, and in particular, the file system 636 and/or the processor (e.g., 621), is configured to perform the aspects of the flowchart in FIG. 4 or FIG. 5.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents. In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a computer-implemented method for updating a central artificial intelligence (AI) model, comprising: receiving, at a communication interface of a central AI model, model logic from multiple remote customer instances of AI models, each customer instance of the AI models being based on the central AI model; updating the central AI model based on a combination of the model logic from the multiple remote customer instances; and providing, via the communication interface, an AI model update to at least a subset of the multiple remote customer instances of the AI models.

In aspect 2, the method of aspect 1 further includes providing, via the communication interface, an initial version of the central AI model, to the multiple remote customers instances prior to receiving the model logic.

In aspect 3, the method of 1 or 2 further includes receiving, at the communication interface of the central AI model, additional model logic from one or more of the multiple remote customer instances of AI models after providing the AI model update; updating the central AI model based on the additional model logic; and providing, via the communication interface, an additional AI model update to the subset of the multiple remote customer instances of the AI models.

In aspect 4, the method of any of aspects 1-3 further includes that each customer instance corresponds to a business entity, and the model logic corresponds to a pattern of customer behavior identified based on an analysis of customer data at the remote customer instance of the AI model.

In aspect 5, the method of any of aspects 1-4 further includes that the model logic excludes information of all customers within the customer data used to identify the pattern of customer behavior.

In aspect 6, the method of any of aspects 1-5 further includes that the model logic comprises one or more logic rules abstracted from data and encrypted using fully homomorphic encryption.

In aspect 7, the method of any of aspects 1-6 further includes that for each remote customer instance of the AI model, the communication interface comprises a secure channel with the central AI model.

In aspect 8, the method of any of aspects 1-7 further includes merging the model logic from the multiple remote customer instances of the AI model using ensemble learning.

In aspect 9, the method of any of aspects 1-8 further includes that the AI model update comprises a delta update relative to a prior version of the central AI model.

Aspect 10 is a non-transitory computer-readable medium storing computer executable code for information modeling, the code when executed by processor circuitry causes a central AI model system to perform the method of any of aspects 1-9.

Aspect 11 is an apparatus for information modeling at a central AI model system, comprising memory and one or more processors configured to cause the central AI model system to perform the method of any of aspects 1-9.

Aspect 12 is a processing system for information modeling at a central AI model system, comprising memory circuitry and processor circuitry coupled to memory circuitry, and based at least in part on information stored in the memory circuitry, the processor circuitry is configured to cause the central AI model system to perform the method of any of aspects 1-9.

Aspect 13 is a computer-implemented method for identifying logic patterns at a decentralized artificial intelligence (AI) model, comprising: inputting customer data to an AI model at a remote customer; identifying, using the AI model, model logic based on the input customer data; providing, via a communication interface, the model logic to a central AI model; and receiving, via the communication interface, a model update for the AI model from the central AI model.

In aspect 14, the method of aspect 13 further includes that identifying the model logic includes identifying variations in patterns in output from the AI model based on the input customer data.

In aspect 15, the method of aspect 13 or 14 further includes receiving, via the communication interface, an initial version of the central AI model prior to receiving the model logic.

In aspect 16, the method of any of aspects 13-15 further includes providing, via the communication interface, additional model logic to the central AI model after receiving the model update; and receiving, via the communication interface, an additional AI model update from the central AI model.

In aspect 17, the method of any of aspects 13-16 further includes that the remote customer corresponds to a business entity, and the model logic corresponds to a pattern of customer behavior identified based on an analysis of the customer data at the remote customer.

In aspect 18, the method of any of aspect 17 furtherer includes that the model logic excludes information of all customers within the customer data used to identify the pattern of customer behavior.

In aspect 19, the method of any of aspects 13-18 further includes that the model logic comprises one or more logic rules abstracted from data and encrypted using fully homomorphic encryption.

In aspect 20, the method of any of aspects 13-19 further includes that the communication interface comprises a secure channel with the central AI model.

In aspect 21, the method of any of aspects 13-20 further includes that the model update comprises a delta update relative to a prior version of the central AI model.

In aspect 22, the method of any of aspects 13-21 further includes receiving a user selection of a setting to control sharing of the model logic or reception of updates from the central AI model.

In aspect 23, the method of any of aspects 13-22 further includes that the model logic is provided without access to the input customer data, and the input customer data is not derivable from the model logic that is provided to the central AI model.

Aspect 24 is a non-transitory computer-readable medium storing computer executable code for identifying logic patterns at a decentralized artificial intelligence (AI) model, the code when executed by processor circuitry causes the decentralized AI model to perform the method of any of aspects 13-23.

Aspect 25 is an apparatus for identifying logic patterns at a decentralized artificial intelligence (AI) model, comprising memory and one or more processors configured to cause the decentralized AI model to perform the method of any of aspects 13-23.

Aspect 26 is a processing system for identifying logic patterns at a decentralized artificial intelligence (AI) model, comprising memory circuitry and processor circuitry coupled to memory circuitry, and based at least in part on information stored in the memory circuitry, the processor circuitry is configured to cause the decentralized AI model to perform the method of any of aspects 13-23.

What is claimed is:

1. A non-transitory computer-readable medium storing computer executable code for information modeling, the code when executed by processor circuitry causes a central AI model system to:
receive, at a communication interface of a central AI model, model logic from multiple remote customer instances of AI models, each customer instance of the AI models being based on the central AI model;
update the central AI model based on a combination of the model logic from the multiple remote customer instances; and
provide, via the communication interface, an AI model update to at least a subset of the multiple remote customer instances of the AI models.

2. The non-transitory computer-readable medium of claim 1, wherein the code when executed by the processor circuitry further causes the central AI model system to:
provide, via the communication interface, an initial version of the central AI model, to the multiple remote customers instances prior to receiving the model logic.

3. The non-transitory computer-readable medium of claim 1, wherein the code when executed by the processor circuitry further causes the central AI model system to:
receive, at the communication interface of the central AI model, additional model logic from one or more of the multiple remote customer instances of AI models after providing the AI model update;
update the central AI model based on the additional model logic; and
provide, via the communication interface, an additional AI model update to the subset of the multiple remote customer instances of the AI models.

4. The non-transitory computer-readable medium of claim 1, wherein each customer instance corresponds to a business entity, and the model logic corresponds to a pattern of customer behavior identified based on an analysis of customer data at the remote customer instance of the AI model.

5. The non-transitory computer-readable medium of claim 4, wherein the model logic excludes information of all customers within the customer data used to identify the pattern of customer behavior.

6. The non-transitory computer-readable medium of claim 1, wherein the model logic comprises one or more logic rules abstracted from data and encrypted using fully homomorphic encryption.

7. The non-transitory computer-readable medium of claim 1, wherein the model logic is received without access to individual customer data, and the individual customer data is not derivable from the model logic.

8. The non-transitory computer-readable medium of claim 1, wherein for each remote customer instance of the AI model, the communication interface comprises a secure channel with the central AI model.

9. The non-transitory computer-readable medium of claim 1, wherein the code when executed by the processor circuitry further causes the central AI model system to:
merge the model logic from the multiple remote customer instances of the AI model using ensemble learning.

10. The non-transitory computer-readable medium of claim 1, wherein the AI model update comprises a delta update relative to a prior version of the central AI model.

11. The non-transitory computer-readable medium of claim 1, wherein the model logic is received without access to individual customer data, and the individual customer data is not derivable from the model logic.

12. A non-transitory computer-readable medium storing computer executable code for information modeling, the code when executed by processor circuitry causes a decentralized AI model system to:
input customer data to an AI model at a remote customer;
identify, using the AI model, model logic based on the input customer data;
provide, via a communication interface, the model logic to a central AI model; and
receive, via the communication interface, a model update for the AI model from the central AI model.

13. The non-transitory computer-readable medium of claim 12, wherein identification of the model logic is based on variations in patterns in output from the AI model based on the input customer data.

14. The non-transitory computer-readable medium of claim 12, wherein the code when executed by the processor circuitry further causes the decentralized AI model system to:
receive, via the communication interface, an initial version of the central AI model prior to receiving the model logic.

15. The non-transitory computer-readable medium of claim 12, wherein the code when executed by the processor circuitry further causes the decentralized AI model system to:
provide, via the communication interface, additional model logic to the central AI model after receiving the model update; and
receive, via the communication interface, an additional AI model update from the central AI model.

16. The non-transitory computer-readable medium of claim 12, wherein the remote customer corresponds to a business entity, and the model logic corresponds to a pattern of customer behavior identified based on an analysis of the customer data at the remote customer.

17. The non-transitory computer-readable medium of claim 16, wherein the model logic excludes information of all customers within the customer data used to identify the pattern of customer behavior.

18. The non-transitory computer-readable medium of claim 12, wherein the model logic comprises one or more logic rules abstracted from data and encrypted using fully homomorphic encryption.

19. The non-transitory computer-readable medium of claim 12, the communication interface comprises a secure channel with the central AI model.

20. The non-transitory computer-readable medium of claim 12, wherein the model update comprises a delta update relative to a prior version of the central AI model.

21. The non-transitory computer-readable medium of claim 12, wherein the code when executed by the processor circuitry further causes the decentralized AI model system to:
receive a user selection of a setting to control sharing of the model logic or reception of updates from the central AI model.

22. The non-transitory computer-readable medium of claim 12, wherein the model logic is provided without access to the input customer data, and the input customer data is not derivable from the model logic that is provided to the central AI model.

23. The non-transitory computer-readable medium of claim 12, wherein the model logic is provided without access to the input customer data, and the input customer data is not derivable from the model logic that is provided to the central AI model.
